(19) United States
(12) Patent Application Publication
(10) Pub. No.: US 2014/0379723 A1
(43) Pub. Date: Dec. 25, 2014

(54) AUTOMATIC METHOD FOR PROFILE DATABASE AGGREGATION, DEDUPLICATION, AND ANALYSIS

(71) Applicant: iAMscientist Inc., Bedford, MA (US)

(72) Inventors: David Page, Manchester, MA (US); Boris Shakhnovich, Brookline, MA (US)

(73) Assignee: iAMscientist Inc., Bedford, MA (US)

(21) Appl. No.: 14/372,763

(22) PCT Filed: Jan. 15, 2013
(86) PCT No.: PCT/US2013/021543

§ 371 Date: Jul. 17, 2014

Related U.S. Application Data
(60) Provisional application No. 61/588,546, filed on Jan. 19, 2012.

(51) Int. Cl. G06F 17/30; H04L 29/08

(52) U.S. Cl. CPC G06F 17/30424; G06F 17/30595; H04L 67/1097
USPC 707/740; 707/769

(57) ABSTRACT

A computing system may obtain first information from a first source of information relating to each of a plurality of entities. The first information may then be processed to identify a set of entities. Information about entities in the set may be used to search a second source of information to obtain second information relating to one or more of the entities in the set. The first information and second information collected for each of the plurality of entities may be processed to create a database of profiles of each of the plurality of entities.

### BACKGROUND

There is great interest for making connections through the Internet. This desire for making connections is especially evident in the context of social media and networking sites including, for example, Facebook, Myspace, and LinkedIn. Once connected, electronic sharing of information about common interests is then possible.

When people use social media and networking sites, they tend form electronic connections based on people they already know or are known to people they already know. It is also possible for people to identify others using the Internet. A person, for example, can search the Internet for a others who have published papers on a particular topic of interest.

### SUMMARY

The inventors have recognized that with regards to making connections between individuals and organizations, it may be useful to identify information which can be used to describe each individual. By identifying the useful information, it is possible to enable the searching, and finding, of relevant individuals based on that information. The use of passive aggregation of available information as opposed to aggregation of user generated content may be helpful if the gathered information can be uniquely assigned to and uniquely identify a real individual.

The inventors have also recognized and appreciated the need for a method and system to more reliably identify entities, based on electronically available information, that have a desired characteristic, such an area of expertise or interest. Such a system may create and index, by desired characteristic, a collection of information relating to those entities. Such a system may automatically sort through multiple information sources, containing information related to multiple entities, to provide information regarding those entities in a useful format.

More specifically, the inventors have recognized and appreciated the benefits of a system and method that can automatically, or semi-automatically, compile and process information from multiple information sources containing information related to multiple entities to generate comprehensive profiles of individuals using predetermined characteristics of each entity. The resulting comprehensive profiles and associated characteristics could be of use making electronic connections among individuals. However, the current disclosure is not limited to these uses, and such a method and system are capable of being used for any number of different applications.

In one aspect, the invention may be embodied as a method of operating a computing system. In some embodiments, the computing system may obtain first information from a first source of information relating to each of a plurality of entities. The first information may then be processed to identify a set of entities. Information about entities in the set may be used to search a second source of information to obtain second information relating to one or more of the entities in the set. The first information and second information collected for each of the plurality of entities may be processed to create a database containing a profile of entities combined from the combination of the two sources.

In some embodiments, the second information may be used to update the information about the entities in the set, and the updated information about the entities may be again used to search a third source of information. The process of updating the information about the entities in the set and searching subsequent sources of information based on the updated information may be repeated iteratively until a stop condition is detected. The stop condition, for example, may occur when no new information can be gained about each entity, when there are no more sources to search, or when an iteration of existing sources fails to reveal further information about any of the plurality of entities.

In some embodiments, the entities may be individuals. In some embodiments, the individuals may be identified as authors of, or as otherwise being associated with, documents in the first source of information. The entities may thus be identified by processing of documents in the first source and subsequent sources.

The first source may be one or more databases or other data stores in which information of a predetermined type is stored. The second source may be a general source of information, in which information is not limited by type. For example, the first source may include one or more databases of scientific publications and the second source may be the Internet. In such a scenario, the plurality of entities may be scientists and the profiles may identify areas of expertise of each scientist and publications about the work by the scientist.

In a further aspect the invention may be embodied as a computerized store of profiles about each of a plurality of entities. Each profile may include an identity of an entity, a classification of the entity derived from a plurality of documents and information identifying the plurality of documents. In some embodiments, the profiles may also include information regarding the background, expertise, and/or interests of each identified entity.

In yet other embodiments, a system may be connected to first and second sources of information. The system may include a processor and memory. The processor and memory may include instructions to download first information from the first information source to the memory. The instructions may also instruct the processor to process the downloaded information to identify information regarding a plurality of entities. The identified information may be used by the system to search the second source for second information and download the second information to the memory. The aggregated information in the memory containing the first and second information may be processed to create a profile for each entity.

The foregoing is a non-limiting summary of the invention.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a representative schematic of a system connected to different databases through a network and the internet for the purpose of compiling and processing information related to generate a database of profiles;

FIG. 2 is a representative table of the information contained in a database of profiles;

FIG. 3 is a representative flow diagram of the process for generating a database of profiles;

FIG. 4 is a representative flow diagram of the process for deduplicating aggregated entities from different data sources;

FIG. 5 is a representative flow diagram of the process for quickly and efficiently deduplicating individual content from different data sources; and

FIG. 6 is a simplified representative flow diagram of the process for generating a database of profiles.

### DETAILED DESCRIPTION

The inventors have recognized the advantages of a system and method for automatically, or semi-automatically, creating profiles related to a plurality of entities from multiple databases of information. The profiles may include information relating to relevant characteristics of the individual entities. The profiles may be related to a characterization of individual entities which may be, for example, characterizations of authors of a set of publications. Alternatively, the methods described below could be applicable to inventory management, shipping management, expertise, interest, relationship and connections mapping, data mining, forms and documents identification, businesses, institutional and government profiling, and legal profiling, medical and other offices.

For the sake of clarity, the following description of the systems and methods for generating the desired profiles is given in the context of identifying individuals, for example scientist, from available publications, patents, grants, conference proceedings, and other information uniquely attributed to each author. However, it should be understood that the current disclosure is not limited to this example. Instead, as would be apparent to one of skill in the art, the current disclosure should be interpreted as being applicable for generating profiles regarding any type of entity from information derived from multiple sources of information.

In general the method for generating the above noted profiles begins by identifying one or more initial information sources to use for defining the initial information set containing authors of publically available publications, grants, patents and other materials. In some embodiments, these data sources may be the type known to contain information relevant to a desired characteristic that is in some way linked to individuals. The major information sources may be identified manually using experts in the field. Alternatively, the major information sources may be identified automatically using automatic lists of publication indices. Alternatively, the information sources may be identified through the use of web-search or indexing services such as Google, Bing, or Yahoo. The information source can also be manually transcribed from a non-digital source such as a catalog, manual, or any other appropriate source. The resources may be public resources or databases. Alternatively, the resources may be protected, or confidential, databases. In the example of scientists, these data sources may be databases of: technical publications which may be linked to individuals who authored them; patents which may be linked to individual inventors who filed them; grant proposals which may be linked to individuals who submitted them; conference proceedings which may be linked to individuals who spoke or attended the event; clinical trials which are linked to individuals who performed the trials; and/or information created by or for individuals related to their profile.

To permit viewing and processing of the information present in the initial information sources, the information from the identified information sources may be collected and aggregated into a single repository. To enable the collection and aggregation of the information, it may be desirable to implement either a manual or an automatic download of the information from the identified initial information sources. For instance, the identified resources may be downloaded either through an API (application program interface) or though the web UI (user interface). As an example, the data may be downloaded using a “web-scraper”, a file transfer protocol, or any other appropriate digital recovery methods. To manage the data downloads, an automatic mechanism may be created by which the relevant materials are extracted from the web-pages served online, or wholly by interfaces provided by the indexing service either in HTML, JSON, XML or any other format which is applicable.

The downloaded documents may be in a variety of formats which can then be parsed to extract the relevant information into a common data model that can be stored in either a document or relational database. Therefore, relevant information can be extracted from various sources and a holistic picture of the information gathered from each document can be aggregated.

When multiple sources, or sources with duplicate information are utilized, a deduplication step may be necessary to identify documents which are the same. This can be done by comparing the documents to each other using a probabilistic algorithm that looks at commonalities between the document properties that may include, but is not limited to, title, abstract, co-authorship, affiliation, full text, supplementary materials, URL, keywords, or any other property commonly defined within the documents.

The documents can then be applied to ontology services for annotation. The annotation can either be performed automatically or manually by experts. For the purpose of efficient storage and download, in some embodiments it may be advantageous to further enable the information to be downloaded in parallel and placed in a distributed file system.

During the initial steps of identifying relevant information from the initial information sources, it may be undesirable to limit the available information. Consequently, it may be desirable to have no requirements on the type of information or source placed on the downloads at this stage in the process. For example, there may be no requirements regarding the date of publication of an identified article or the source of the information. Due to the accuracy of the deduplication explained above and the clustering of entities such as profiles explained below, this method can accept a large amount of “noise” information which does not relate to the entities or documents in the original set. Therefore it may not be necessary to have manual reliability metrics that limit the information sources. Furthermore, the downloaded information may contain all of the identified relevant information, or any subset of the identified relevant information, regarding the entities associated with the information. The downloaded unstructured data may be placed as raw data into a database with no loss of accuracy in the system.

In the present example of authors and related publications, the downloaded raw information may contain relevant information regarding titles, abstracts, journals, dates of publication, authors, co-authors, affiliation information, research interests, personal information, address information, work or education history, phone, email, fax, photographs, work history, mentorship history, students, post-docs, patents, and/or grants. Each piece of information may include all, or only a subset, of the desired relevant pieces of information. For example, one piece of information may include title and abstracts of one publication while another piece of information may include address and phone/email information. The information may be downloaded from websites, directly from publishers, or from indexing resources such as PubMED or ISI.

The downloaded information may be de-duplicated, as described above, by identifying similar identified publications and creating a unique, non-overlapping set of publications that may be used later in clustering and profile creation.

The downloaded de-duplicated information may be analyzed and the authors of each identified publication may be extracted. The authors, along with other relevant information such as keywords describing the area of expertise and interests, may be extracted from each publication. The names of the authors and the keywords may then be used to search for similar content available on the open web, but which was not downloaded in the initial aggregation of information. Any search engine, including for example Google or Bing, may be used to discover the additional material. The information discovered through the search may then be downloaded and added to the collection of information to form an aggregated collection of information. The keywords may then be updated using the extracted information. Search for new content can be weighed by ontological terms extracted from the new data in the database. New authors can be added to the database if their co-authors are already in the database from the previous iteration. This process may be repeated until no new information can be found on the web which is not duplicated in the already-downloaded information.

For each author, the documents attributable to the authors are collected. After completion of author name extraction, each document and author tuple may be embedded into a multi-dimensional space where the content describes the keywords (based on an ontology) that are used as dimensions. One of the ways to accomplish clustering may be to build vectors (one vector for each publication) and group them into clusters by authors or on any other user-defined parameter. To build clusters we can use a “merge nearest” algorithm, where the distance function is defined in terms of cosine metrics. Formally (in declared terms). Cosine metrics distance: cosineDistance(p₁, p₂)=cos(p₁, p₂). So, orthogonal vectors may correspond to absolutely different publications when the cosine of the angle between them is equal to 0, and the distance is infinite. Collinear vectors (corresponding to absolutely equal publications) will have a zero angle and the cosine and distance will be equal to 1. The merging process may stop if a distance between two merge candidates (closest vectors) greater than a predetermined threshold (obtained empirically). Vectors corresponding to publications can be built using any weighting of the data from document information extracted from aggregation and deduplication explained above including but not limited to: co-authors and colleagues; document keywords; affiliation information; name; text in abstracts; URL of document; dates of publications; full text of document; Address; email; phone or educational information; and/or any other relevant information extracted from the documents.

Apart from the cosine distance described above, other distance functions may be used including, but not limited to, a Laplacian, Eigen, Euclidian, Manhattan, or any other distance metric that can be defined using two vectors in multi-dimensional space.

Simple machine learning algorithms (such as K-means or any other clustering algorithm) can then be applied to merge documents with the same author that appear close to each other in the high-dimensional space to create full profiles of each author. Each cluster may then be used to uniquely define the profile of each author. Relevant information can be extracted from each cluster such as keywords for each author describing the interests or expertise associated with that author.

The end result may be a collection of profiles for authors that contain all of the documents that can be attributed to them. Each author profile may describe all of the materials uniquely attributed to the author. The database of profiles can be used to extract information about areas of interests, expertise, bibliography, ranking, practices, or other information about the author. The extraction can proceed by matching keywords from an ontology to the documents in the profile, extracting formatted materials such as emails, or phone numbers, or by extracting relevant materials in close proximity to key words or phrases such as “reagent” or “affiliation” or “instrument” or other words that may indicate relevant extracted information. The extracted information can be used to identify key opinion leaders, potential customers or collaborators. A widely used search engine such as Google Appliance or Lucene or Sphinx can be used to identify and rank profiles with respect to any keyword that is extracted from the profile.

The database can be updated by adding additional content and using a simple algorithm to analyze the content to attribute it to the author or authors of that content. The algorithm may be analogous to the clustering algorithm except that it may measure the distance between a single document and all the clusters (author profiles). If there is a single distance which falls below the threshold it may assign the document to the profile with the minimum distance to the article.

Updating the database could modify the author profiles and/or the parameters describing the characteristics of each authors' profile. The author profiles database can be stored in raw form of downloaded into a database to permit searching, indexing, or distribution of the profiles.

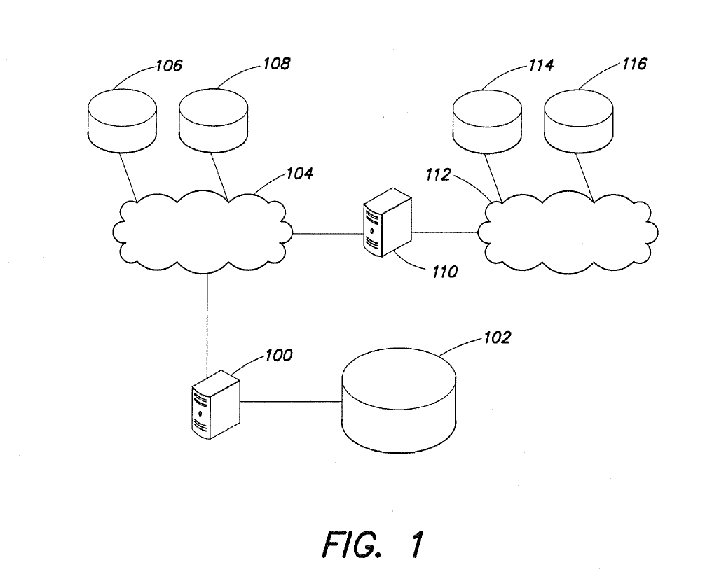

In one embodiment, as shown in FIG. 1, a system 100 may be adapted to implement the above described method may be connected to a local database 102. The system may be connected to a network 104. The initial information set used in the above method may be downloaded from initial information sources 106 and 108 which may be connected to system 100 through the network connection 104. After the initial information set has been downloaded and processed by system 100, the identified entities and associated keywords are submitted to search engine 110. Search engine 110 may perform a search of the internet 112 using the entities and keywords as search terms. The search results may identify additional relevant information located, for example, on secondary information sources 114 and 116. After downloading the information from the secondary information sources 114 and 116, system 100 may process the information as detailed above to de-duplicate the information and identify additional entities and keywords. The system may identify additional information by iteratively searching the internet until an end condition is met. In certain embodiments the initial information sources 106 and 108 may be connected to system 100 through the internet 112 instead of network 104.

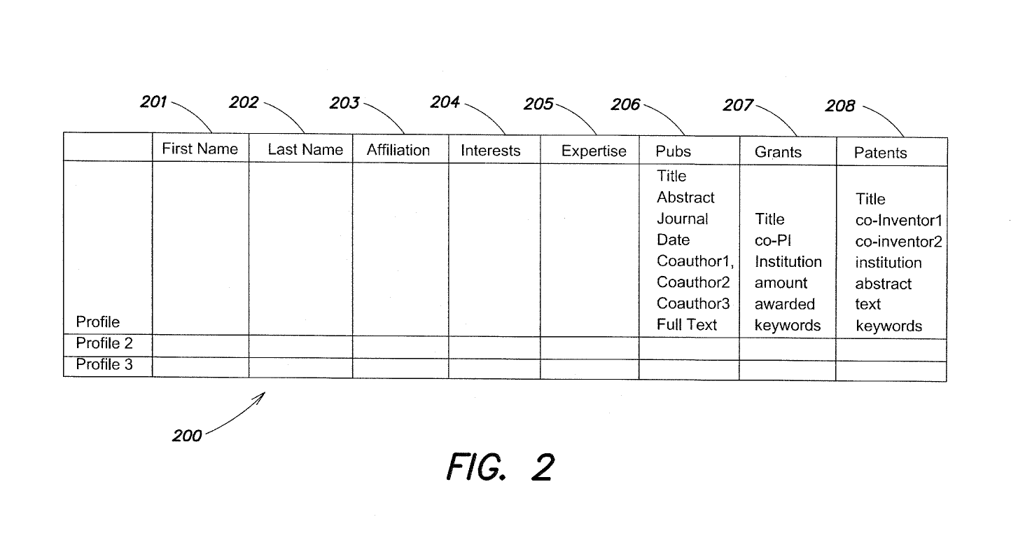

FIG. 2 presents a representative table containing information that might be included in separate profiles identified using the current methods. In some embodiments it may be desirable to include the profiles in a computerized store of profiles 200. The store of profiles 200 may include information regarding personal information including, but not limited to, the first name, last name and affiliation 201-203. The stored profiles may also include information about interests and expertise, 204-205, in keyword format extracted from the relevant documents associated with each profile. The profiles may also include information about publications, grants or patents, 205-208 which may include information pertinent to the individual document entities including titles, dates, coauthors, and text.

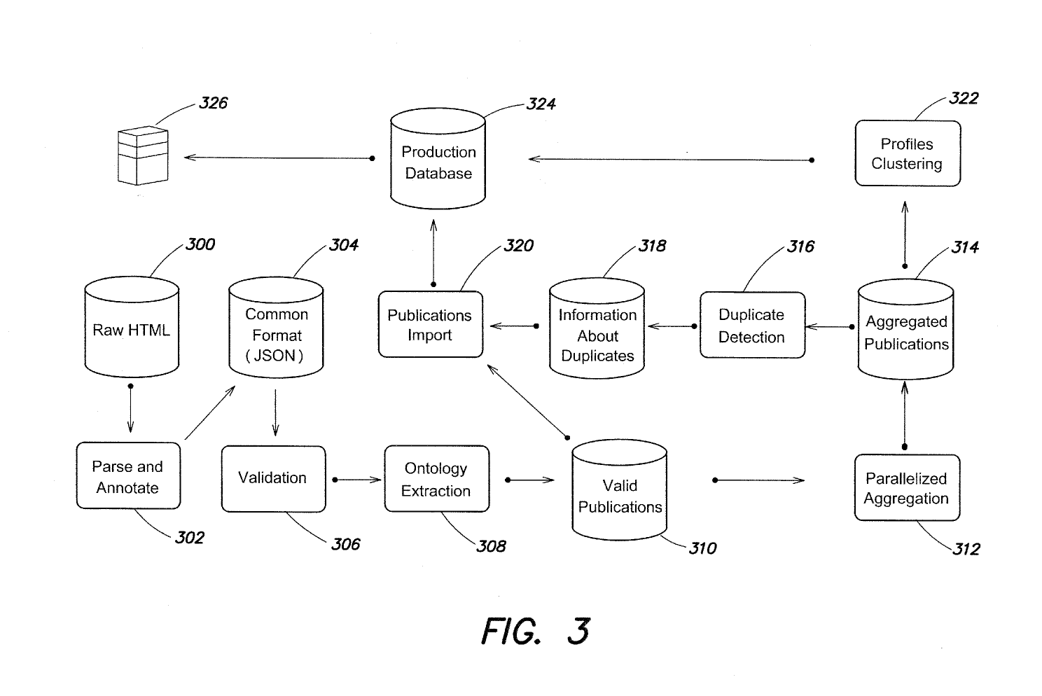

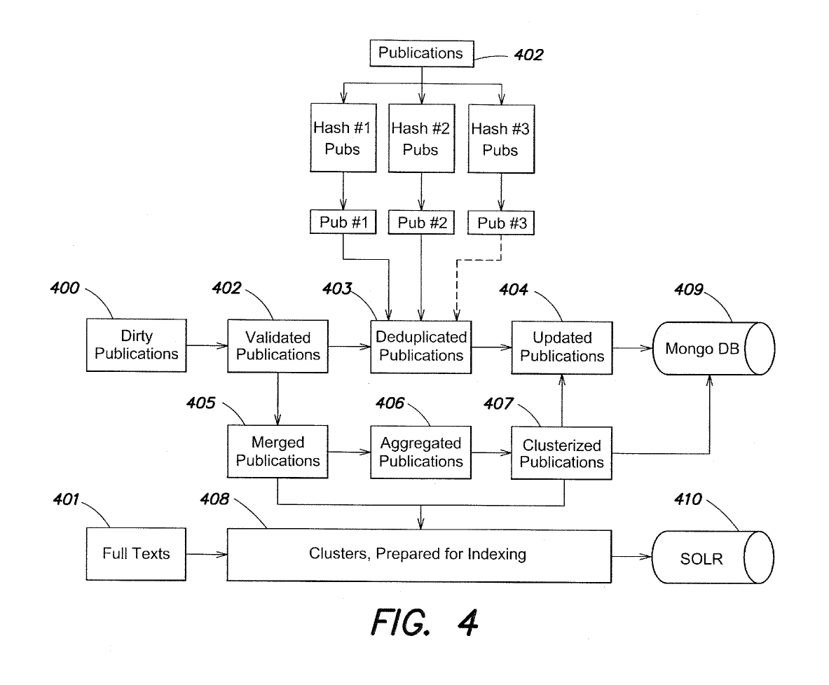

FIG. 3 details one embodiment of the process for downloading and processing information from an information source for inclusion in a processed aggregated database. Initially, information may be downloaded as a initial raw HTML information set 300. The initial information set 300 may be downloaded using any applicable method such as a web-scraper, a file transfer protocol, or any other applicable digital recovery method. The initial information set 300 may be parsed and annotated in step 302 in order to extract the relevant information from the raw HTML and JSON data. The raw documents may then be treated with a parser made specifically for that datatype. While specific data types have been described, it should be understood that other data types could be used. After parsing and annotating the downloaded information, the information may be reformatted into a common format such as JSON or to provide an information set 304 having a consistent and common format throughout. While a common JSON format is described, it should be understood that any common format could be used as the disclosure is not limited in this manner. During step 306, an automatic testing process may be used to ensure that the documents pass certain quality control parameters and tests. After validating the information, in step 306, the information may be subjected to extraction using a regularized ontology in step 308. A MESH ontology may be used. However, any ontology system may be used as the disclosure is not limited in this manner. The preceding steps result in a set of valid publications 310. The process of deduplicating publications and aggregating them as indicated in steps 314-320 is described in more detail in FIG. 4 below. After deduplication and aggregation, the profiles may then be clustered during step 322 and input to production database 324. The clustering may be done by calculating a distance between each publication using a distance matrix and a clustering algorithm such as K-means or empirical monte-carlo clustering. Consequently, production database 324 includes a unique set of imported publications and other information, and a plurality of author profiles associated with and linked to those publications. Production database 324 may be loaded onto a database or other data store 326.

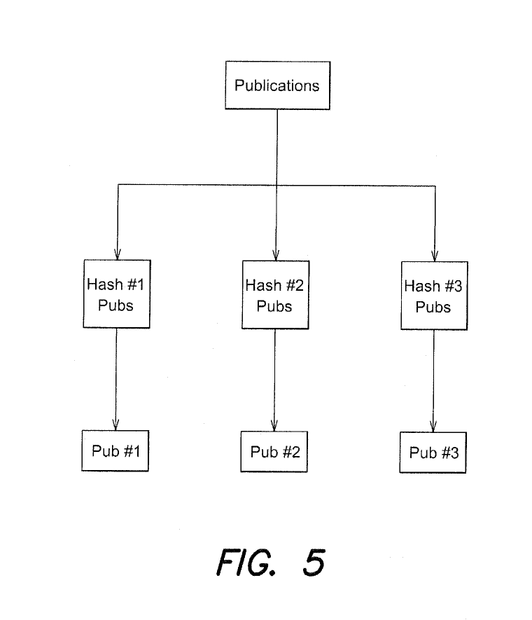

The publications and information aggregation and de-duplication steps noted above are explained in more detail in reference to FIG. 4. An initial set of publications and information may be collected from a variety of sources (400 and 401). The initial set of publications and information may then be validated explained above in step 402. The validated publications and information may be embedded into hashes in step 403a. The hashing process is shown separately in FIG. 5. After hashing, the hashed publications and information may then be used de-duplicate the publications and information in step 403b to result in a set of updated publication and information 404. The publications and information may then be merged and aggregated using the clustering processes described above in steps 405-407. The merged and/or clustered publications and information may then be sent to storage in the database 409 or to be indexed by a search engine 410 as clusters of profiles 408.

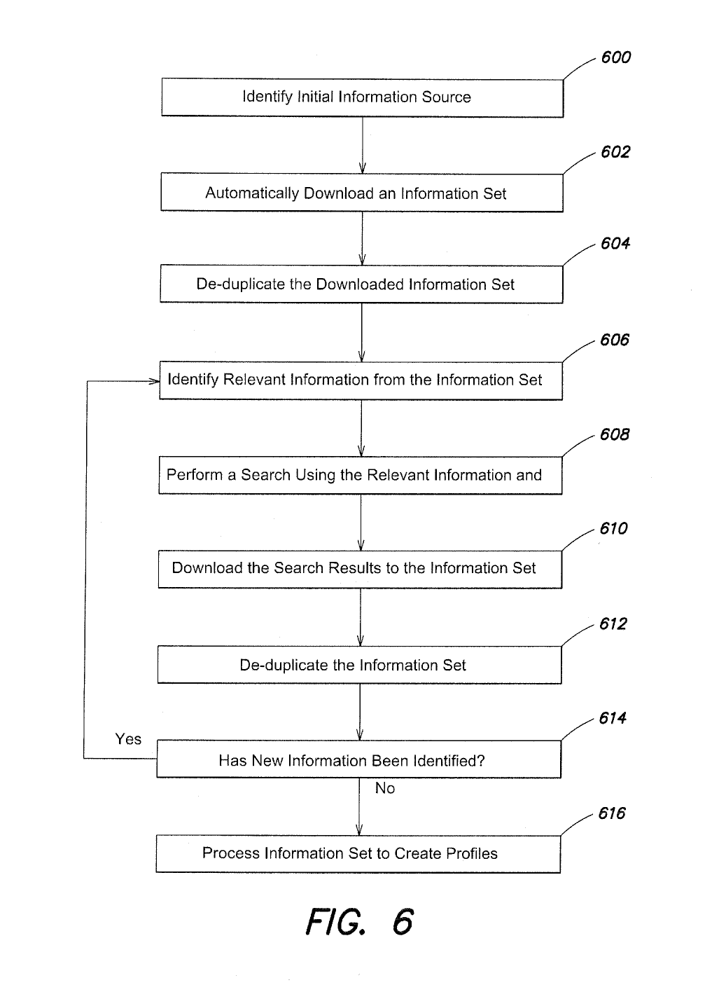

An exemplary process flow chart is detailed in FIG. 6 for identifying and downloading information sets from a plurality of information sources. In step 600 the initial one or more information sources may be manually identified. An information set may then be automatically downloaded during step 602 from the identified information sources. The information set may include distinct pieces of information, for example listings of publications. In some instances, the downloaded information set may include duplicate information. Consequently, the downloaded information set may be subjected to a de-duplicating process in step 604 and as described in more detail above. The resulting de-duplicated information set may then be processed to identify relevant information during step 606 to be used in a subsequent search. The relevant information may include identification of a plurality of entities and key terms associated with the information set. For example, the relevant information may include the names of authors and key terms from identified publications connected with those authors. A search may be performed of a second information source, such as the internet, using the identified relevant information during step 608. The search results may be downloaded to the information set in step 610. Another de-duplication process may be performed in step 612 after downloading the additional information. During step 614, it may be determined whether or not any new information, i.e. a previously unidentified publication, has been identified. If new information has been identified another search may be performed by repeating steps 606-614. This iterative searching process may be continued until no new information is found during the search process. After the iterative search process has been completed, the information set may be processed in step 616 to create individual profiles of each entity associated with the information set, as described in more detail above.

The description of the machinery for aggregating content, annotating it, extracting keywords and other parts of the algorithm described in this patent application can be equally applied to any document set including legal forms, military forms, product offerings and other lists of relevant entities on the internet. Given the application of the de-duplication, merging and extraction, the resulting index will contain information which is the union of the information contained in each source individually. The resulting DB can be used to search, connect and describe any parameter in the documents' common to any subset of the documents.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of operating a computing system, the method comprising:
obtaining first information comprising information related to a plurality of entities from a first source of information;
processing the first information to identify a set of entities with at least one processor, using information related to the set of entities to search a second source of information to obtain second information relating to one or more of the entities in the set; and
processing the first and second information to create a database of profiles relating to each of the identified entities.

2. The method of claim 1, wherein obtaining first and second information further comprises obtaining information related to an author, wherein the information includes at least one of:
titles, abstracts, journals, dates of publication, co-authors, affiliation, research interests, personal information, address information, work history, education history, phone number, email, fax number, photographs, mentorship history, students, post-docs, patents, and/or grants.

3. The method of claim 1, wherein obtaining first information from a first source further comprising obtaining first information from a plurality of databases.

4. The method of claim 1, wherein obtaining first information from a from a first source further comprises obtaining structured information related to the set of entities.

5. The method of claim 1 wherein obtaining first and second information further comprises obtaining first and second information using a search engine.

6. The method of claim 1 further comprising processing the second information to update information related to the set of entities.

7. The method of claim 6 further comprising using information related to the updated set of entities to search a third source of information.

8. The method of claim 1 further comprising iteratively updating information related to the set of entities and searching sources of information using information related to the updated set of entities.

9. The method of claim 8, wherein iteratively updating the set of entities and searching sources of information further comprises iteratively updating the set of entities and searching sources of information using information related to the updated set of entities until a stop condition is detected, the stop condition comprising at least one of:
no new information is identified for each entity;
no new entity is identified;
there are no more sources to search; and/or
a search of existing sources does not identify additional information about any of the plurality of entities.

10. The method of claim 1 further comprising making the database of profiles available for search.

11. A system configured for access to first and second sources of information, the system comprising:
a processor and memory, wherein the memory comprises instructions to:
download to the memory first information comprising information related to a plurality of entities from the first source of information;
instruct the processor to process the downloaded first information to identify a set of entities;
use information related to the set of entities to search the second source of information and download to the memory second information relating to one or more of the entities in the set; and
instruct the processor to process the first and second information to create a database of profiles relating to each of the identified entities stored in the memory.

12. The system of claim 11 wherein the processor and memory further include instructions to instruct the processor to process the second information to update the set of entities.

13. The system of claim 12 wherein the processor and memory further include instructions to instruct the processor to use information related to the updated set of entities to search a third source of information.

14. The system of claim 11 wherein the processor and memory further include instructions to instruct the processor to iteratively update information related to the set of entities stored in the memory, search sources of information using information related to the updated set of entities, and download additional information to the memory until a stop condition is detected.

15. The system of claim 14 wherein the stop condition comprises no new information is identified for each entity, no new entity is identified, there are no more sources to search, and/or a search of existing sources does not identify additional information about any of the plurality of entities.

16. The system of claim 11 wherein the processor and memory further include instructions to instruct the processor to make the database of profiles available for search.

17. A computer readable storage medium having computer-executable instructions, the computer-executable instructions being adapted to perform a method comprising:
obtaining first information comprising information related to a plurality of entities from a first source of information;
processing the first information to identify a set of entities;
using information related to the set of entities to search a second source of information to obtain second information relating to one or more of the entities in the set; and
processing the first and second information to create a database of profiles relating to each of the identified entities.

18. The computer readable storage medium of claim 17 wherein the instructions, when executed, further comprise using information related to the updated set of entities to search a third source of information.

19. The computer readable storage medium of claim 17 wherein the instructions, when executed, further comprise iteratively updating the set of entities and searching sources of information using information related to the updated set of entities until a stop condition is detected.

20. The computer readable storage medium of claim 17 wherein the instructions, when executed, further comprise making the database of profiles available for search.
